(19) United States
(12) Patent Application Publication
(10) Pub. No.: US 2019/0300279 A1
(43) Pub. Date: Oct. 3, 2019

(54) Portable Removable and Disposable Waste Collection Apparatus

(71) Applicant: Tossits LLC, Birmingham, MI (US)

(72) Inventors: Carlo Koza, West Bloomfield, MI (US); Donald McIntyre, Royal Oak, MI (US)

(21) Appl. No.: 16/292,296

(22) Filed: Mar. 4, 2019

Related U.S. Application Data
(60) Provisional application No. 62/637,557, filed on Mar. 2, 2018.

(51) Int. Cl. B65F 1/00

(52) U.S. Cl. CPC B65F 1/0013

(57) ABSTRACT

A portable removable and disposable waste collection apparatus comprises at least one bag, a header, and an attachment means. In an embodiment, the header retains and/or supports the at least one bag, the attachment means allows for the at least one bag to attach to an object, and the at least one bag is used as a receptacle for litter. A plurality of bags may be held together and in place by the header of the apparatus. The header may also securely receive the attachment means of the apparatus, such that when a user separates a bag from the apparatus, the attachment means keep the rest of the apparatus attached to an object so that the apparatus can be used again to collect waste, i.e. by way of another unused bag of the plurality of bags.

### CROSS-REFERENCE TO RELATED APPLICATIONS

The present application claims priority under 35 USC § 119 on pending U.S. Provisional Application Ser. No. 62/637,557 filed on Mar. 2, 2018, the disclosure of which is incorporated by reference.

### FIELD OF THE DISCLOSURE

The present disclosure relates to waste collection apparatuses, and, more particularly, to a waste collection apparatus that is portable, removable and disposable and that may be used in a variety of environments.

### BACKGROUND

Waste collection in vehicles is an issue for vehicle and passengers, as the issue involves at least hygiene of the operators and passengers and prevention of littering in our environment. Without an effective way of collection and disposal of waste, individuals in a vehicle are forced to place their trash in open areas of their car, leading to the possibility of having said trash soil and/or damage the interior of the car. The placement of waste in the open areas of the vehicle also may lead to unsanitary conditions, which conditions can harm or otherwise present a health hazard toward its occupants.

Additionally, an effective mechanism for waste collection is necessary in a vehicle in order to reduce the amount of littering in the environment. That is, without a place to discard waste in the vehicle, individuals may instead chose to dispose of their trash outside of their car while driving, leading to a negative environmental impact as well as the commission of a civil or criminal offense.

There have been several solutions presented to the address the need for waste collection in vehicles, yet their shortcomings make clear the need for a more efficient and effective solution. One common solution currently being sold is a standalone multi-use bag that attaches to the back of a seat in a car. However, many of these bags have thick, Velcro strap for attaching the bag around the headrest of the seat in front of it. Because the strap is thick and cumbersome, it can be difficult to attach to the car seat headrest. Due to the size of such a strap, the bag may not be able to stay attached during use and the cumbersome strap may interfere or prevent the headrest from being able to move or be adjusted easily and freely. Furthermore, these multi-use bags must be removed each time they are filled up in order to be emptied and cleaned for further use, and must then be reinstalled before their next use, which amounts to an inefficient cycle of installing, using, removing, emptying, and then reinstalling the same bag.

Another solution to the problem of waste collection in vehicles is in the form of a single-use bag, such as the bags that are made available at a car wash. While such bags may be discarded after they are filled up, they limit the capacity of waste that can be collected at one time since space limitations in vehicles only pert the attachment of one or two such bags in the passenger compartment at any one time. Furthermore, such bags are usually made with thin material that is not resilient and that is therefore prone to ripping. Such bags are also difficult to place within the vehicle, as such single-use bags do not securely attach to any place within the car. That is, such bags may only attach via a fixed-size aperture, which aperture is intended to secure the bag over a radio or air conditioning knob. The attachment means is not adjustable, thereby limiting the places where such a bag can be attached. Further, because such a bag is designed to attach to a radio or air conditioning knob, the bag, when attached, can interfere with user access to radio or air conditioning controls of the vehicle.

The problem of controlling waste collection is present in other environments, as well. Consider the case of a movie theater, where trash receptacles are traditionally located only at or nearby the exit doors of the theaters, which requires patrons to organize their trash that is generated during the viewing of a movie and save it for disposal at the time they exit from the theater. Inevitably, some trash items will fall on the floor or otherwise spill during the course of the viewing, as it is difficult for patrons to hold onto trash items in a dark theater and because theater seating does not otherwise provide space close by to store trash. At the end of the film or viewing event, trash will accumulate on the floor as it is impossible to expect patrons to carry all of their waste items to the few receptacles that are provided. Theater staff thereafter must comb through the theater to collect such loose trash in order to maintain or restore the theater to a sanitary condition, which results in additional labor and time for theater staff and operation of the theater. The same scenario occurs at sports stadiums and, auditoriums, and other venues with large amounts of seating.

Accordingly, there still exists a need for an improved waste collection apparatus that overcomes these various drawbacks in the prior art.

### SUMMARY OF THE DISCLOSURE

In view of the foregoing disadvantages inherent in the prior art, the general purpose of the present disclosure is to provide a waste collection apparatus that is portable, removable and disposable and that may be used in a variety of environments.

In an embodiment, a portable removable and disposable waste collection apparatus comprises at least one bag, a header, and an attachment means. In an embodiment, the header retains and/or supports the at least one bag, the attachment means allows for the at least one bag to attach to an object, and the at least one bag is used as a receptacle for litter.

The at least one bag preferably comprises a plurality of bags, which bags of the plurality of bags are held together and in place by the header of the apparatus. In a preferred embodiment, each bag of the plurality of bags comprises a perforated region. In such an embodiment, the perforated region is configured to allow the bags to be held in place by the header when not in use, but also to be separated from the apparatus and header once the bag has been filled with waste materials. The header may also securely receive the attachment means of the apparatus, such that when a user separates a bag from the apparatus, the attachment means keep the rest of the apparatus attached to an object so that the apparatus can be used again to collect waste, i.e. by way of another unused bag of the plurality of bags.

### DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 shows an exemplary waste collection apparatus, in accordance with an exemplary embodiment of the present disclosure, and

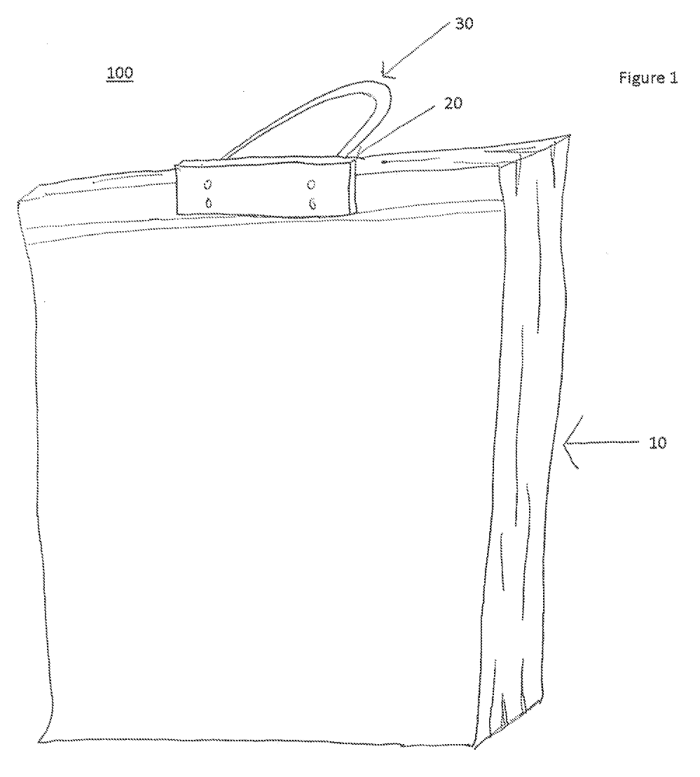

FIG. 2 shows another exemplary waste collection apparatus, in accordance with another exemplary embodiment of the present disclosure.

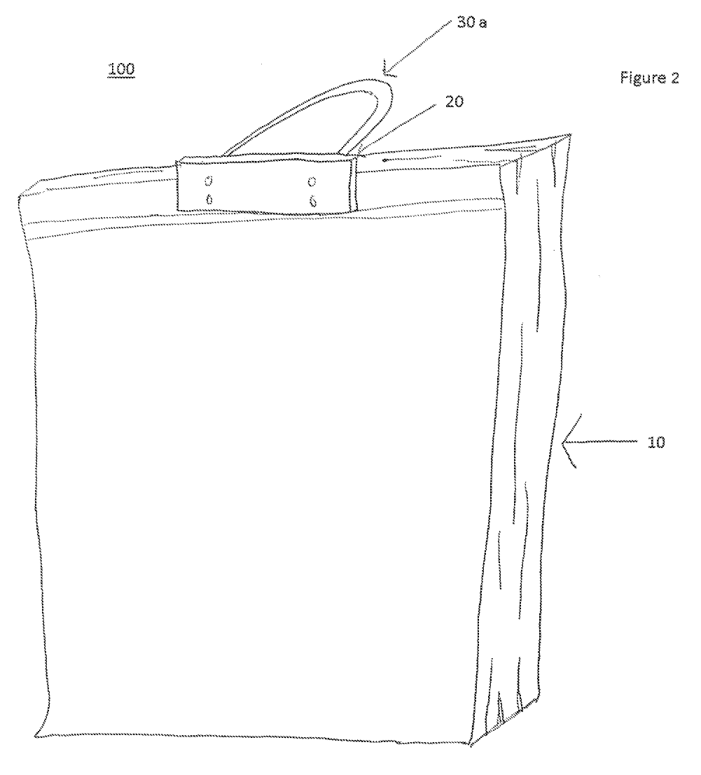

Like reference numerals refer to like parts throughout the description of several views of the drawings.

### DETAILED DESCRIPTION OF THE DISCLOSURE

The best mode for carrying out the present disclosure is presented in terms of its preferred embodiments described herein. The preferred embodiments described herein detail for illustrative purposes are subject to many variations. It is understood that various omissions and substitutions of equivalents are contemplated as circumstances may suggest or render expedient, but are intended to cover the application or implementation without departing from the spirit or scope of the present disclosure.

The terms “a” and “an” herein do not denote a limitation of quantity, but rather denote the presence of at least one of the referenced items.

In an embodiment, a portable removable and disposable waste collection apparatus 100 comprises at least one bag 10, a header 20, and an attachment means 30 (such as a bungee 30a). In an embodiment, the header 20 retains and/or supports the at least one bag 10, the attachment means 30 allows for the at least one bag 10 to attach to locations within a vehicle, for example. or to a seat- or chair back, for example, and the at least one bag 10 is used as a receptacle for litter.

In an embodiment, the at least one bag 10 comprises a bag 10 preferably made from 100% recycled plastic, which bag 10 can be used to securely collect and store waste. In an embodiment, the at least one bag 10 can be removed from the header 20, sealed shut, and disposed of once it has collected a sufficient amount of litter.

In an embodiment, the header 20 comprises a plastic, cardboard, or metal mechanism for holding together the at least one bag 10. Header 20 and at least one bag 10 preferably comprise complementary engagement features that allow secure attachment of the at least one bag 10 to the header 20.

In an embodiment, the attachment means 30 may comprise a bungee 30a, a cord, lanyard, string or other attachment means, which attachment means 30 may connect the header 20 and, in an embodiment, the at least one bag 10, to an object, such as the headrest of automobile seat or the back of a seat (such as a theater or stadium seat, for example). In a preferred embodiment, the bungee 30a comprises an elastic material that allows for secure attachment of the apparatus 100 to objects of various sizes and configurations. It will be apparent that header 20 may have apertures (or other suitable engagement features) for receiving ends of the bungee, cord, or lanyard, for example, so that the bungee, etc. can be securely attached to the header for use of the apparatus.

The at least one bag 10 preferably comprises a plurality of bags, which bags of the plurality of bags are held together and/or in place by the header of the apparatus 100. The header 20 may be configured to surround opposing sides of the bags of the plurality of bags. In another embodiment, the header 20 may be attached to one of the bags of the plurality of bags.

In a preferred embodiment, each bag 10 of the plurality of bags comprises a perforated region 12. In such an embodiment, the perforated region 12 is configured to allow the bags to be held in place by the header 20 when not in use, but also to allow the bags to be separated from the apparatus 100 and header 20 once a bag 10 has been filled with waste materials. The header 20 may also securely receive the attachment means 30 of the apparatus 100, such that when a user separates a bag 10 from the apparatus 100 the attachment means 30 keep the rest of the apparatus 100 (such as the header 20 and remaining bags) attached to an object so that the apparatus 100 can be used again to collect waste, i.e. by way of a new and/or unused bag 10 of the plurality of bags.

The plurality of bags may be vertically disposed against one another and be at least partially compressed together in such a vertical orientation either by the header 20 or by an adhesive or binder. The compression of the plurality of bags and the perforated region 12 of the bags facilitates separation and removal of one bag 10 of the plurality of bags after the bag 10 is filled with refuse or waste. It will be apparent that the header 20 and perforation 12 are such that a bag 10 of the plurality of bags that is in use (i.e., ready to receive waste) may be disposed in the apparatus 100 such that an opening of the bag 10 can be exposed and be accessible to users such that the users can easily insert waste or garbage items into the bag in question. Furthermore, the header 20 and perforated region 12 of an at least one bag 10 may be configured such that one side or portion of the bag 10 may be removed from attachment to the header 20 or other bags to open the bag 10 for collection of waste but to also have the bag 10 retained on the header 20 so that it is in a secured/stable position for use. It will be apparent that the bags may have creases or folds or may be elastic to an extent to allow expansion of the interior volume of the bag 10 to allow for accumulation and storage of waste therein. The plurality of bags is not restricted to any particular dimensions and may come in a variety of colors and materials.

Each at least one bag 10 of the plurality of bags may further preferably comprise a closure mechanism 40 (such as an adhesive strip that may be covered by a wrapper or other material until the strip is ready to be exposed, or a drawstring or other fastening mechanism that is at least partially incorporated in the material of the bag). The adhesive region may be used to securely close the bag after the bag 10 has been filled with enough waste that the bag 10 is ready for removal from the apparatus 100. In an embodiment, the user may utilize the closure mechanism 40 after the bag 10 is removed from the apparatus 100 by exposing the adhesive strip and folding the bag 10 over on itself such that any opening of the bag 10 is closed and retained securely by the closure mechanism 40. In another embodiment, the closure mechanism 40 comprises a drawstring that may be used to close the open or top portion of the at least one bag 10 once the bag 10 has been filled and/or a user is done, at least temporarily, with collecting waste. Once a bag 10 of the plurality of bags is so closed, the bag 10 can be placed in a larger garbage receptacle without concern for having any refuse that was placed inside of the bag 10 of the apparatus 100 escape or otherwise leak from the bag 10 and/or be set upon the environment. Instead, the closure of the bag 10 allows for organized control and disposal of waste with a minimum of loss or leakage during the process.

In use, the apparatus is suitable as a receptacle for litter within an automobile or other confined space or space where a seats are provided to accommodate a mass of people (such as a stadium, theater or classroom). The ease of attachment of the apparatus to a headrest or seatback provides for waste collection facilities in widespread locations throughout a vehicle or other confined space and therefore minimizes the instances of litter or loose waste accumulating. The plurality of bags allows for multiple uses of the apparatus such that it does not need to be replaced once a first bag has been filled to capacity. The elasticity and light weight of the attachment means allows for easy and quick attachment and removal of the apparatus to and from objects or fixed items of various sizes

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the disclosure and various embodiments with various modifications as are suited to the particular use contemplated.

What is claimed is:

1. A waste collection apparatus, the apparatus comprising at least one bag, a header, and an attachment means,
wherein the header supports the at least one bag and the attachment means attaches the at least one bag to an object to permit a bag of the at least one bag to be removed from the apparatus after use of the bag of the at least one bag and to have another bag of the at least one bag remain attached the object.

2. The apparatus of claim 1, wherein the attachment means comprises one of a bungee, cord, lanyard, and a string.

3. The apparatus of claim 1, wherein the header comprises one of plastic, cardboard, and metal.

4. The apparatus of claim 1, wherein the at least one bag comprises a plurality of bags that are held together by the header.

5. The apparatus of claim 4, wherein the plurality of bags are vertically disposed and compressed against one another.

6. The apparatus of claim 1, wherein the at least one bag comprises a perforated region.

7. The apparatus of claim 6, wherein the perforated region of the at least one bag is configured such that a portion of said at least one bag may be removed from the apparatus such that an opening of said at least one bag is exposed.

8. The apparatus of claim 1, wherein the at least one bag comprises a closure mechanism.

9. The apparatus of claim 8, wherein the closure mechanism comprises one of an adhesive strip and a drawstring.

10. At least one bag of a waste collection apparatus, the apparatus further comprising a header and an attachment means,
wherein the header supports the at least one bag and the attachment means attaches the at least one bag to an object to permit a bag of the at least one bag to be removed from the apparatus after use of the bag of the at least one bag and to have another bag of the at least one bag remain attached the object.

11. The apparatus of claim 10, wherein the attachment means comprises one of a bungee, cord, lanyard, and a string.

12. The apparatus of claim 10, wherein the header comprises one of plastic, cardboard, and metal.

13. The apparatus of claim 10, wherein the at least one bag comprises a plurality of bags that are held together by the header.

14. The apparatus of claim 13, wherein the plurality of bags are vertically disposed and compressed against one another.

15. The apparatus of claim 10, wherein the at least one bag comprises a perforated region.

16. The apparatus of claim 15, wherein the perforated region of the at least one bag is configured such that a portion of said at least one bag may be removed from the apparatus such that an opening of said at least one bag is exposed.

17. The apparatus of claim 10, wherein the at least one bag comprises a closure mechanism.

18. The apparatus of claim 17, wherein the closure mechanism comprises one of an adhesive strip and a drawstring.
